(19) United States
(12) Patent Application Publication
(10) Pub. No.: US 2006/0030332 A1
(43) Pub. Date: Feb. 9, 2006

(54) Method and system for geolocation of wireless transmissions using distributed processors in wireless receiver towers and a method for collecting a fee for processing geolocation requests

(76) Inventors: David T. Carrott, Bristow, VA (US); Brian L. Kessler, Oakton, VA (US)

Correspondence Address: ANDREWS KURTH LLP;Intellectual Property Department, 1701 Pennsylvania Avenue, N.W., Suite 300, Washington, DC, 20006, US

(21) Appl. No.: 10/911,687

(22) Filed: Aug. 5, 2004

(51) Int. Cl. G01S 3/02

(52) U.S. Cl. 455/456.1

(57) ABSTRACT

A system and method for geolocation of wireless transmitters and a business method for collecting a fee for the geolocation. The system includes multiple cell towers and a central system administrator linked to the cell towers. Each cell tower includes a geolocation processor, capable of performing geolocation calculations for wireless transmitters, and a database. The method includes receiving a request for geolocation of a wireless transmitter, identifying the wireless transmitter in the vicinity of a plurality of cell towers, collecting the raw signal information generated by the identified wireless transmitter that is received at the primary cell tower and adjacent cell towers, calculating the geolocation of the wireless transmitter, recording the geolocation information, and disseminating the geolocation information to the requester or a third party. The business method includes receiving a request for geolocation of a wireless transmitter, calculating the geolocation, recording the geolocation information, disseminating the geolocation information to the requester or a third party, and charging a fee for processing the geolocation request.

### BACKGROUND

A traditional cell phone system that supports the transmission and receipt of cellular telephone calls consists of a primary cell tower that is linked to one or more secondary cell towers through a central base processor. FIG. 2 illustrates a traditional cell phone system. These cell towers are connected with each other and with a central base processor by high-speed links such as a T1 line (1.544 Mbps) or an OC-1 link. Each cell tower is accurately surveyed for geolocation information (latitude, longitude, and altitude). In these traditional cell phone systems, the cell towers do not have processors.

Typically, a full cell phone system (e.g., see FIG. 2) can contain as many as a hundred cell towers in a large city or as few as 15 cell towers in a small city. Cell towers are typically spaced at distances of one-half mile to 20 miles, depending on the line-of-site restrictions of the terrain. Cell towers contain at least one antenna and frequently more. The additional antennas provide added frequency capability to the cellular area for cell phones (both analog and digital).

The support architecture of a cell phone system involves frequency reuse and is implemented by the use of distinct frequencies around a cluster of cell towers. Adjacent cell towers do not use the same frequencies, and if more than one antenna is used at a cell tower, then additional frequencies can be reused around that cell tower. The more frequencies allowed in a cell phone system, the more complex the mixture pattern of overlapping cell towers and frequencies. The FCC allocates the frequency spectrum to be used by cell phone communications, which is then divided into bands for wireless carriers.

A crude method of cell phone geolocation, with a circular error of probability (CEP) of miles, takes advantage of the following features of existing systems: cell towers (e.g., see FIG. 3) and cell phone broadcast power settings (e.g., see FIG. 4). The system could determine the distance from the primary cell tower by ascertaining the cell phone's power setting (through an inquiry from the cell tower) and determining the cell phone's signal strength at the primary cell tower. The power setting is set by the cell phone based upon the strength of the handshake signal between the cell phone and the primary cell tower. The power setting is inversely proportional to the distance between the cell phone and the primary cell tower and it is set in fixed power values. These power settings vary with the manufacturer, battery capability, and the distance from the primary cell tower. Where cell towers are spread far apart (large coverage area) due to low user traffic or open line-of-sight, using the power setting to determine the distance from the primary cell tower results in poor accuracy. The radial area of the cell tower coverage divided by the power setting range, for a three-step phone (i.e., a phone with three levels of transmission power), can be anywhere from ⅓ mile (one-mile radius) to ˜7 miles (21-mile radius). Also, this crude method requires additional programs to be run, additional handshaking between the cell tower and the cell phone transmitter (requesting power setting), and is time consuming. All of this limits the number of users that can be accurately located at a given time.

Traditional cell phone systems may also use Global Positioning System (GPS) technology to provide geolocation information to cell phone users. Utilizing GPS technology in a traditional cell phone system, multiple GPS satellites transmit location information to a GPS receiver in the cell phone. This GPS geolocation is limited by inherent GPS interferers (e.g., atmospheric, space weather, radio frequency, and urban landscapes). Moreover, the GPS technology requires that a GPS receiver be installed in each cell phone (which is costly), and the geolocation information must be initiated by the cell phone user.

Accordingly, performing geolocation in traditional cell phone systems has a number of disadvantages. Many of these disadvantages are due to the presence of only a central base processor for multiple cell towers in a traditional cell phone system. The central base processor can only process geolocation information for one cell phone inquiry at a time; the speed of required links from cell towers to the central base is limited (by modem, T1, OC-1, etc.) and, therefore, increases the time to process geolocation information; and, the central base processor cannot accurately process geolocation information from a cell phone in motion. Other disadvantages are due to the problems inherent in GPS technology: existing systems cannot accurately determine position when inherent GPS interferers are present, and there is a considerable length of time required for GPS-capable receivers to acquire an initial GPS signal from space.

### SUMMARY

A system and method for geolocation of wireless transmitters that overcome the above disadvantages. Also described is a business method for generating revenue based on geolocation requests. A system for geolocation of wireless transmitters includes multiple cell towers and a central system administrator (CSA) linked to the cell towers. Each cell tower includes a geolocation processor, capable of performing geolocation calculations for wireless transmitters, and a database.

A method for geolocation of a wireless transmitter includes receiving a request for geolocation of the wireless transmitter, identifying the wireless transmitter in the vicinity of a plurality of cell towers, collecting, from a primary cell tower and adjacent cell towers, raw signal information generated by the identified wireless transmitter, calculating the geolocation of the wireless transmitter, and disseminating the geolocation information to the requester or a third party. The identification process is based upon the fact that each wireless transmitter has a unique identification tag that can be exploited.

A computer readable medium containing instructions for geolocation of a wireless transmitter, by receiving a request for geolocation of the wireless transmitter, identifying the wireless transmitter in the vicinity of a plurality of cell towers, collecting from a primary cell tower and adjacent cell towers raw signal information generated by the identified wireless transmitter, calculating the geolocation of the wireless transmitter, and disseminating the geolocation information to the requester or a third party. The identification process is based upon the fact that each wireless transmitter has a unique identification tag that can be exploited.

A method for generating revenue based on geolocation requests includes receiving a request for geolocation of a wireless transmitter, calculating the geolocation of the wireless transmitter, disseminating the geolocation information, and charging a fee for processing the geolocation request.

### DESCRIPTION OF THE DRAWINGS

FIG. 1 is a diagram illustrating an embodiment of a system for geolocation of wireless transmissions.

FIG. 2 is a diagram illustrating a traditional cell phone system.

FIG. 3 is a diagram illustrating cell towers with multiple antennas.

FIG. 4 is a diagram illustrating a single tower geolocation using cell phone broadcast power settings and multiple cellular antennas.

FIG. 5 is a diagram illustrating a single cell tower in an embodiment of a system for geolocation of wireless transmissions.

FIG. 6 is a diagram illustrating the potential use of an optical signal processor to calculate bearing information for latitude, longitude, and altitude.

FIG. 7 is a diagram illustrating an existing GPS geolocation system next to an embodiment of a system for geolocation of wireless transmissions.

FIG. 8 is a diagram illustrating the principle of TDOA superposition.

FIG. 9 is a diagram illustrating TDOA triangulation calculations.

FIG. 10 is a diagram illustrating a snapshot of a wireless transmitter signal at a time synchronous point at three cell towers.

FIG. 11 is a diagram illustrating intersecting parabolic PDOA plots.

FIG. 12 is a diagram illustrating multiple, overlapping hyperbolic TDOA plots.

FIG. 13 is a diagram illustrating a paired hyperbolic TDOA plot.

FIG. 14 is a flowchart illustrating a method of geolocation of wireless transmissions.

FIG. 15 is a diagram illustrating a method of TDOA geolocation calculations for an airborne wireless transmitter.

### DETAILED DESCRIPTION

A method and system for geolocation of wireless transmissions using distributed processors in wireless receiver towers, and for the dissemination of that geolocation information, is described herein. The method and system overcome the disadvantages of the existing technologies for determining geolocation.

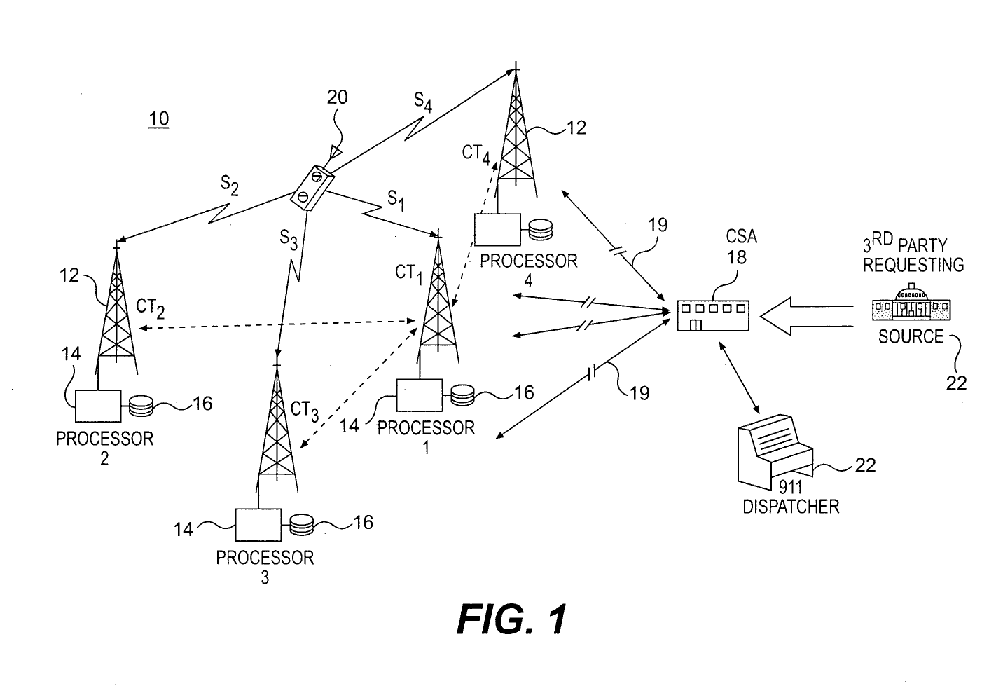

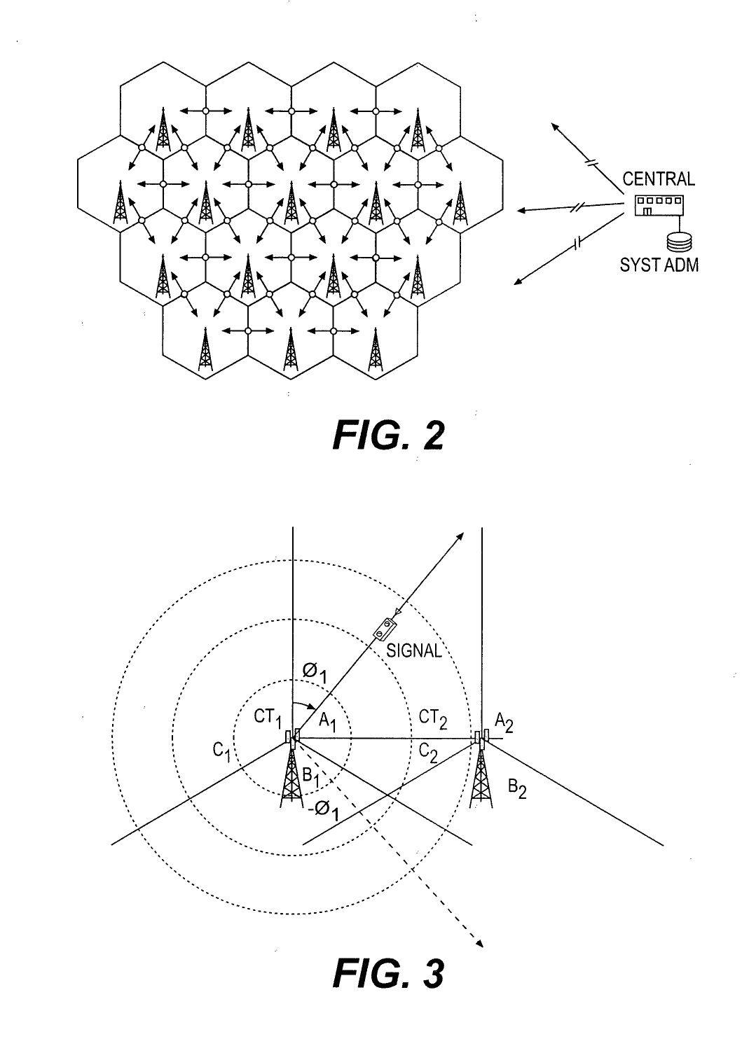

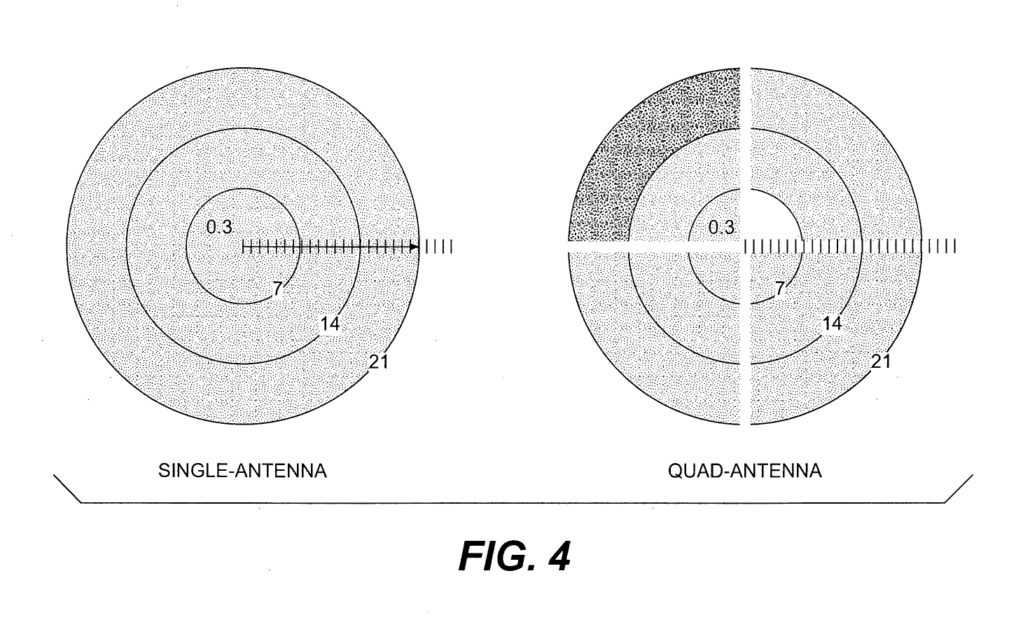

With reference to FIG. 1, shown is an embodiment of a system 10 for geolocation of wireless transmissions. The system 10 for geolocation of wireless transmissions comprises multiple cell towers 12 (e.g., CT₁ to CT₄), each cell tower including a geolocation processor 14 (e.g., Processor #1 to Processor #4) and a database 16, a central system administrator 18 (CSA) linked via links 19 to the cell towers 12 and the geolocation processors 14, and one or more wireless transmitters 20 (e.g., cell phone).

Each geolocation processor 14 may include, for example, one or more digital signal processors or an optical processor. By including a geolocation processor 14 in each cell tower 12, as opposed to just the CSA 18, the system 10 for geolocation of wireless transmissions overcomes the inherent disadvantages of traditional cell phone systems described above. The database 16 may include wireless transmitter 20 identification information, a log of geolocation requests, a list of wireless transmitters 20 whose signals are currently being received by the cell tower 12, and other information ordinarily stored in cell tower 12 databases. In addition to the database 16, each geolocation processor 14 may have associated with it a memory and secondary storage (e.g., CD-ROM) containing instructions, executed by the geolocation processor 14, for performing the various methods and processes, including the geolocation calculations, described herein. These instructions may be in the form of software applications, processor codes and/or modules. The CSA 18 may update these instructions periodically via the links 19. Alternatively, updated instructions may be uploaded directly at each cell tower 12 (e.g., using a CD-ROM).

The system 10 is a cell tower-based system, with distributed processors in cell towers, that is capable of providing, for every cell phone that is powered on, geolocation information to geolocation requesters 22, e.g., public service instrumentalities (e.g., “911” emergency response units), state and local governments, cell phone utilities, and cell phone users. The system 10 features a distributed processing capability, short link distances (i.e., links between cell towers (not shown)), and the capability to process geolocation information for multiple cell phones (e.g., tens, hundreds, or more) simultaneously. The ability to process multiple location inquiries simultaneously is dependent upon the Processor Configuration and the Geolocation Configuration. The Processor Configuration is the number of discrete digital processors or the equivalent number of processors internal to an optical processor. The Geolocation Configuration is the specified accuracy of geolocation information (i.e., bearing, latitude, longitude, altitude, and/or velocity). The system 10 also includes a method for generating a revenue stream that is linked to each use of the cell tower-based geolocation system, rather than just the sale or licensing of the technology that is used to create the system. The method is described in detail below.

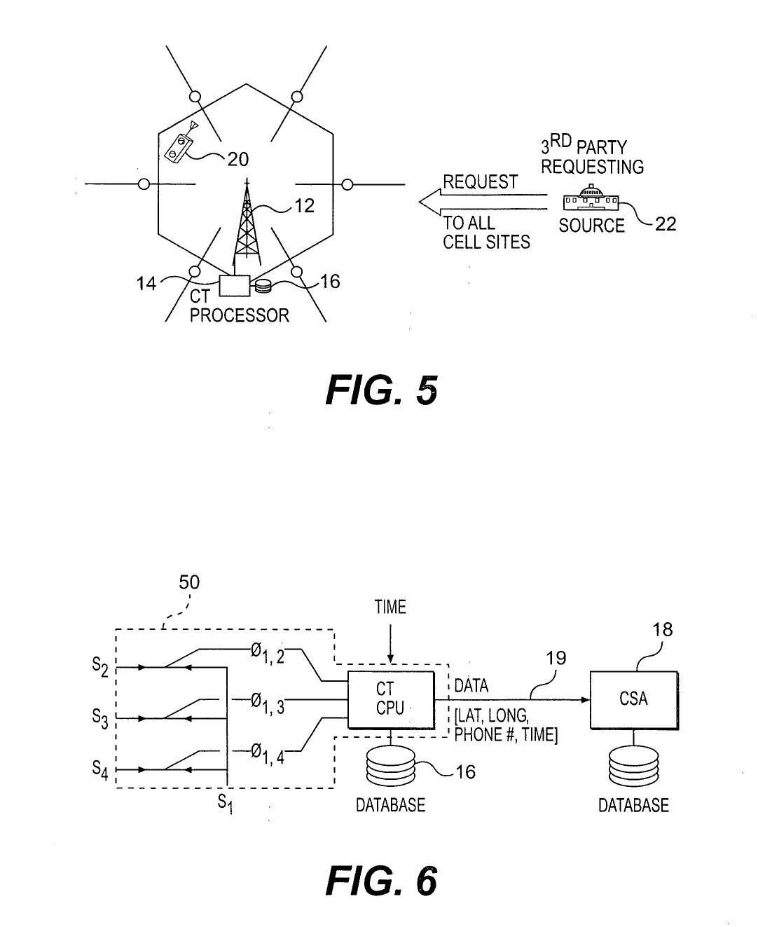

There are multiple embodiments of the system 10 for geolocation of wireless transmissions including:
A single inquiry system utilizing a geolocation processor 14 comprising one digital processor per cell tower 12 with the ability to process one location inquiry at a time per cell tower. (See FIG. 5.)
A multiple inquiry system in which the geolocation processor 14 at each cell tower 12 comprises multiple digital processors or an optical processor (e.g., the optical processor of U.S. Pat. No. 6,424,754). (See FIG. 6.) The resulting cell tower-based geolocation system can be used simultaneously (a) by public service instrumentalities (e.g., first responders) to geolocate the cell phones of multiple cell phone users who call “911”; (b) by governmental entities to geolocate the users of specified cell phones; and (c) by cell phone users to obtain geolocation information about themselves. This embodiment can be used to locate any cell phone that is powered on.
A process by which a royalty is generated from the use of the cell tower-based geolocation system each time the system is used, e.g., to generate and provide geolocation information for each “911” cell phone call placed, each geolocation inquiry from a governmental agency, and each geolocation inquiry from a cell phone user. (See FIG. 1.)

With reference again to FIG. 1, the CSA 18 is the central data collection and distribution system for the cell tower 12 grid. The CSA's 18 primary role is to track all wireless transmitter 20 usage for billing purposes, so that the information can be distributed to the correct cell phone utility (e.g., Cingular, Sprint, Verizon, etc.). For example, if a cell phone user makes a “411” inquiry, the system bills a fixed charge for the service against that phone number. At the end of each billing period, the system extracts all billings by phone number, and distributes the billings to the correct cell phone utility.

The CSA 18 can also update cell tower processor codes, databases, and cell tower survey data. Accordingly, the CSA 18 may be a general purpose computer or server. The CSA 18 may include a processor, memory, secondary storage, display, input and output devices, network interfaces, etc. The memory and secondary storage may contain instructions, executed by the processor, for performing the various methods and processes, in conjunction with the geolocation processors 14, described herein. These instructions may be in the form of software applications, processor codes and/or modules. Other implementations well known to those skilled in the art of electronic commnunications may include: application-specific integrated circuits (ASICs), field-programmable arrays (FPGAs), digital signal processors (DSPs), etc.

The cell tower database 16 may include a global database and a local database. A global database includes: (a) cell phone numbers, disseminated from the CSA 18, that require geolocation each time the signal is received; (b) determined geolocations for the cell phone numbers; (c) the date and time associated with each geolocation; and (d) requester identification. A local database includes: (a) cell phone numbers of cell phone users who generate a geolocation request either by dialing “911” or by dialing a predetermined number, thereby initiating a “where am I?” request (e.g., “211” or any other predetermined number or character or sequence of numbers and/or characters); (b) the determined geolocations for the cell phone numbers; (c) the date and time associated with each geolocation; and (d) the dialed number (i.e., either “911” or the predetermined number initiating the “where am I?” request). On a periodic basis, the CSA 18 will request information from the databases for billing purposes.

In the use of the global and local databases, there may be a legitimate 2^{nd} party inquiry (by a cell phone utility) or 3^{rd} party inquiry (e.g., by a government instrumentality) about the geolocation of a cell phone user. In this case, the CSA 18 uploads the cell phone number into each cell tower's 12 local database 16. Then all cell phone calls handled at the cell tower 12 are compared to the local database 16 to determine if there is a cell phone number match. If a match exists, then the appropriate information is passed back to the CSA 18 for dissemination. In the case of a “911” call, the cell phone number is added to the local list as highest priority, until the CSA 18 is commanded by a “911” Dispatcher (i.e., the emergency response dispatcher) to remove the number from the cell tower database. That way the number is locally tracked and the information is continuously sent to the Dispatcher, even if the connection to the Dispatcher is broken.

With the system 10 described herein, the cell phone user may make a “211” call (i.e., a “where am I?” request) to inquire as to their geolocation. For billing purposes, this may be treated in the same manner as a “411” call when the geolocation information of the cell phone is sent back to the cell phone of the caller. This information, for example, may include latitude/longitude (depending on the Geolocation Configuration), where the cell phone could have a mapping system to help the user, or the CSA 18 could provide the user with an additional service (for an additional cost) by transmitting a picture map of where the user is located.

With continued reference to FIG. 1, the system 10 for geolocation of wireless transmissions applies to any wireless transmitter with a distributed receiver/transmitter network (e.g., cell phones, pagers, and Blackberry devices). The wireless transmitters in the system may include any of these or combinations thereof.

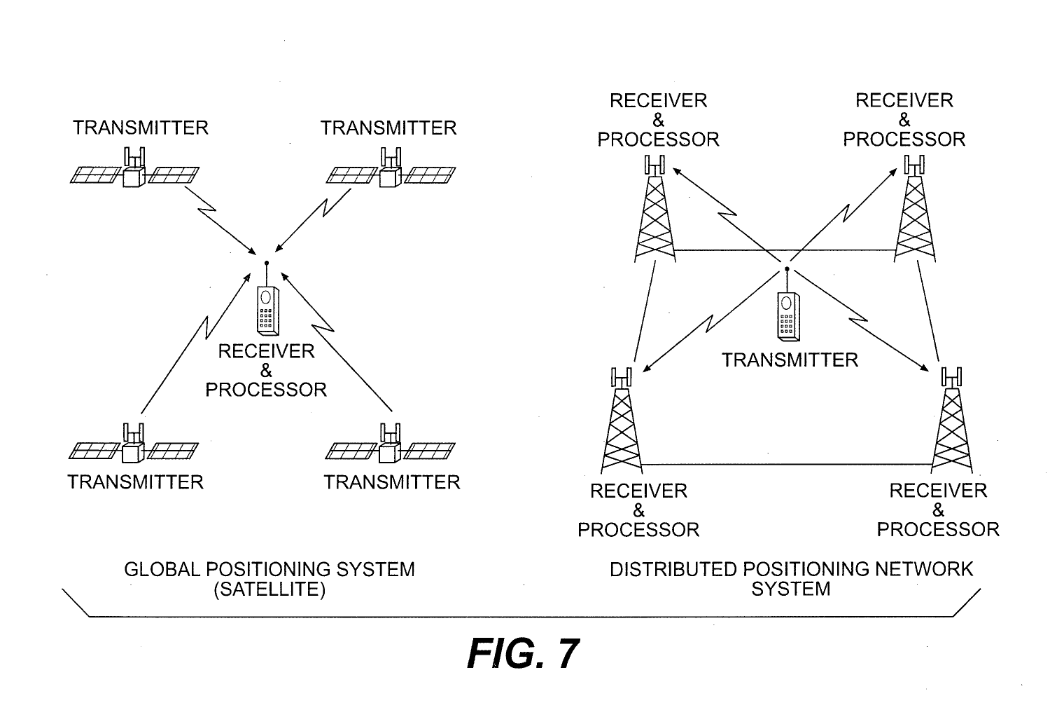

The system 10 for geolocation of wireless transmissions can perform simultaneous processing of geolocation information from multiple secondary cell towers 12, just like a GPS system can. However, the simultaneous processing performed by the system 10 is significantly different from processing performed by the GPS system. In a GPS system, the GPS satellites transmit the signals that are received by the GPS handsets, whereas with the system 10 for geolocation of wireless transmissions (using distributed processors in wireless receiver towers) the cell phones are the transmitters 20 and the cell towers 12 (with the geolocation processors 14) are the receivers. FIG. 7 illustrates this difference. It is important that the receiver and processor are integrated: with the GPS system, they are in the handheld unit, whereas with the system 10 for geolocation of wireless transmissions, they are in the cell towers 12.

With continuing reference to FIG. 1, the various embodiments of the system 10 for geolocation of wireless transmissions may utilize a number of any geolocation technique to perform geolocation calculations. For example, the system 10 for geolocation of wireless transmissions may utilize any of the techniques described in U.S. Pat. Nos. 5,512,908, 6,201,499, and 5,327,144, “Performance of Hyperbolic Position Location Techniques for Code Division Multiple Access,” George A. Mizusawa, Thesis for M.S. in Electrical Engineering—Virginia Tech, August 1996, and “Position Location Using Wireless Communications on Highways of the Future,” Rappaport et al., IEEE Communications Magazine, October 1996. There are many methods known to those skilled in the art for performing geolocation calculations. The following are provided as examples.

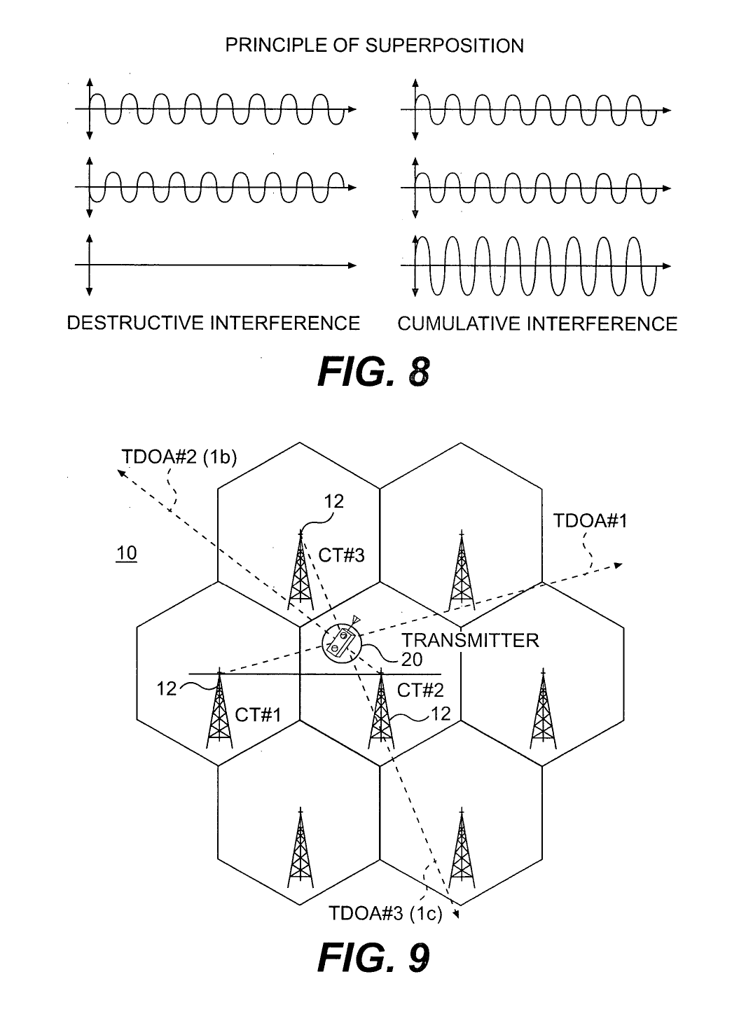

One of the geolocation processing methods is commonly referred to as time difference of arrival (TDOA). TDOA is a well-known navigational tool to determine the location of a transmitter from three or more remote sites, using triangulation. TDOA is based on the Principle of Superposition (as shown in FIG. 8) that utilizes destructive interference in order to define in-phase conditions. Any degree of being out-of-phase is proportional to the bearing from the primary cell tower to the wireless transmitter (e.g., a cell phone user). An effective process involves the use of three (or more) intersecting bearing angles from three (or more) separate cell towers, as shown, e.g., in FIG. 9. This can be done by a primary cell tower 12 (CT #1), a first secondary cell tower 12 (CT #2), and a second secondary cell tower 12 (CT #3), where the strength of the signals (S) from the transmitter 20 to each cell tower (CT #1, CT #2 and CT #3) decreases from the strongest to weakest (S₁, S₂, S₃, respectively).

With continued reference to FIG. 9, TDOA # 1 is determined by S₁ (primary), at CT #1, computed against S₂ (secondary), at CT #2. Then, CT #1 requests that CT #2 compute TDOA #2 based on S₁ and S₂. Alternatively, CT #1 may compute TDOA #2 as if it were CT #2, using S₂ data received from CT #2. Since TDOA #1 is a function of the delay between the timings of S₁ and S₂ (phase measurement), with this delay known, the bearing angle from CT #2 to the wireless transmitter can be determined. The intersection of these two bearings provides two possible geolocations of the wireless transmitter, one a true geolocation and one a ghost (or false) geolocation. The same process described herein regarding CT #1 and CT #2 can be used to add a third bearing based on CT #1 and CT #3 to determine TDOA #3. The true geolocation is determined by the single point at which all three bearings, TDOA #1, TDOA #2, and TDOA #3, intersect. By traditional navigation processing using TDOA or the other techniques described herein: to determine latitude and longitude, three bearings are needed (which provides improved CEP over two bearing); to determine altitude, four bearings are needed; and, to determine velocity, five bearings are needed. Additional cell towers 12, and hence additional bearings, may be utilized to improve the accuracy of any of these determinations without added dimensionality.

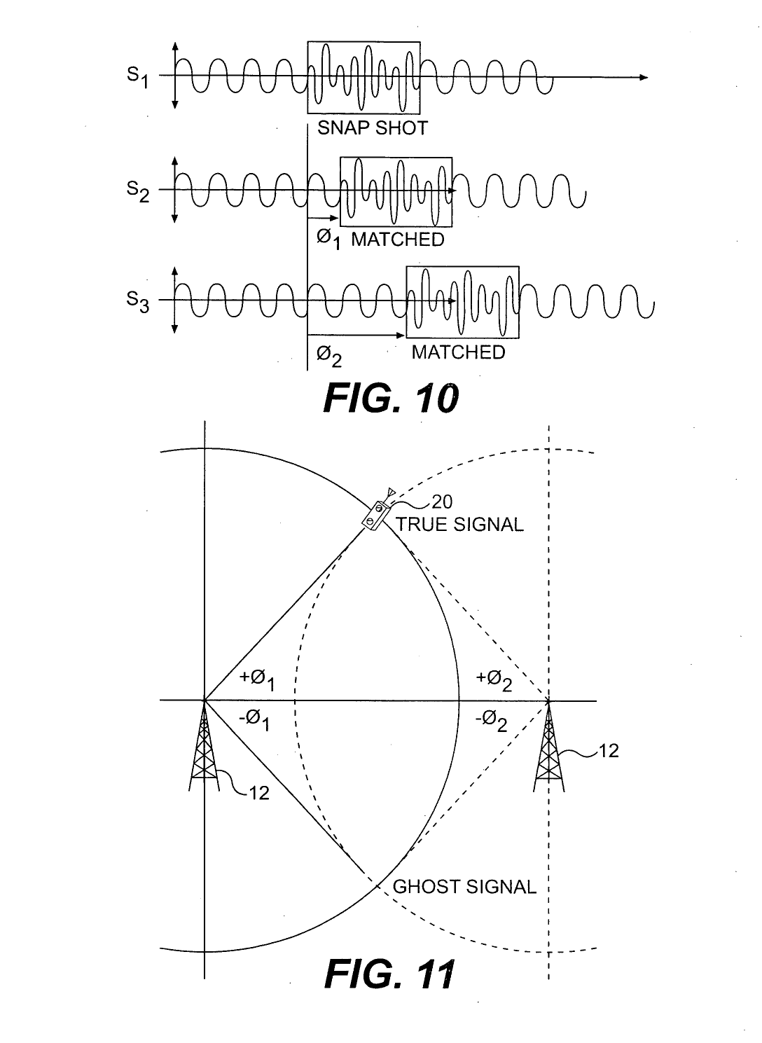

With reference again to the method and system shown in FIG. 1, another way of calculating geolocation is as a phase difference of arrival (PDOA). The PDOA method estimates the difference in the arrival times of the same source signal received at two or more receivers (cell towers). This is accomplished by taking a snapshot of the signal at a time synchronous point at the applicable cell tower 12. FIG. 10 illustrates such a snapshot. As seen in FIG. 10, the signals S₁, S₂, S₃, received at the three cell towers CT #1, CT #2, and CT #3, are plotted over time. It is assumed that such a signal S₁ in time has unique and distinguishable characteristics. That way it can be compared to the signal (S₂ and S₃) received by two other receivers (i.e., cell towers), where there can be found a signal match with a phase shift in time (i.e., a cross-correlation). FIG. 10 shows this signal matching.

Therefore, the cross-correlation between receptions at pairs of cell towers will provide a peak output that defines the phase difference of the signal. As shown in FIG. 11, this phase difference between the pair of receivers is shown as parabolic plots around each receiver (cell tower). These plots intersect at two points between the pair of cell towers. The wireless transmitter (e.g., cell phone) can exist at only one of the two points. The true geolocation can be determined by using the third receiver (i.e., cell tower CT #3).

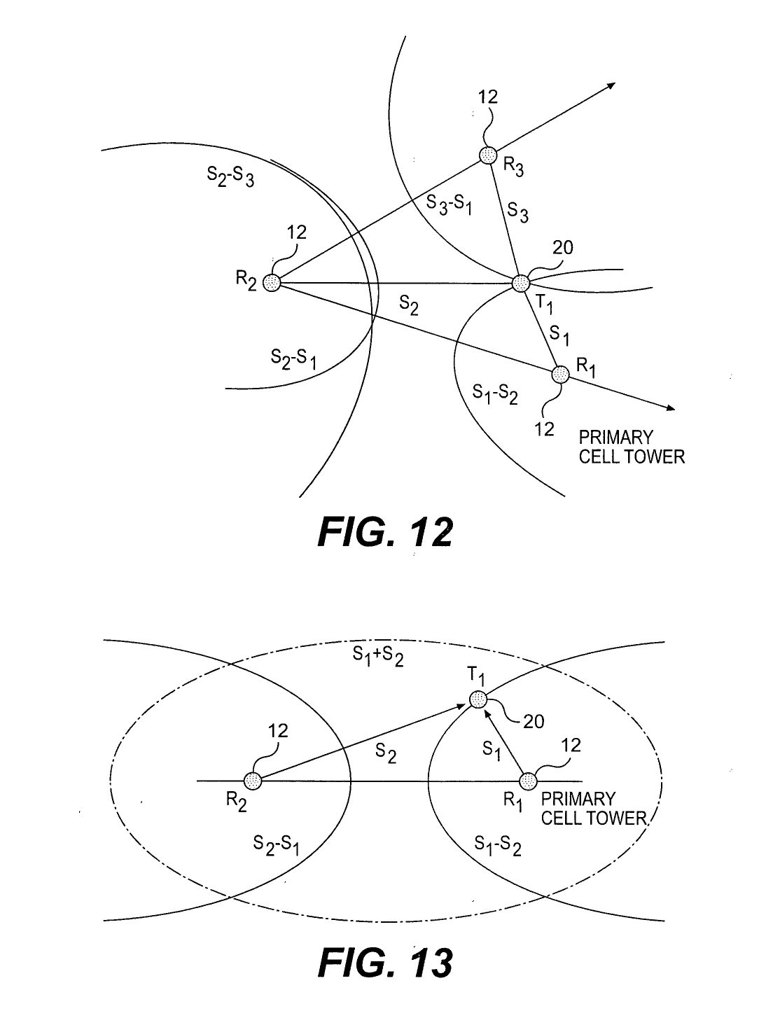

With reference again to FIG. 1, the system 10 for geolocation of wireless transmissions may also determine geolocation using a hyperbolic method of TDOA. With the hyperbolic method, the relationship between the transmitter (T₁) and the receivers (R₁, R₂, and R₃) is simplified into hyperbolic plots of receiver pairs (i.e., R₁ and R₂, R₁ and R₃), as shown in FIG. 12. R₁ is the primary receiver and R₂ and R₃ are the secondary receivers. The lateral leg between R₁ and T₁ is S₁, and the lateral leg between R₂ and T₁ is S₂. The respective difference in the lateral leg pairs (i.e., S₂−S₁) provides a constant value that is a dipole hyperbolic plot (see FIG. 13), as opposed to an elliptical plot about two foci (which is the sum of the lateral leg pairs [i.e., S₂+S₁]). When multiple hyperbolic plots are overlapped (see FIG. 12), the hyperbolic plots around the secondary receivers (R₂ and R₃) will intersect at the location of the transmitter (T₁). Therefore, the plots about the primary receiver (R₁) are not necessary (i.e., S₁−S₂, S₁−S₃), thereby reducing the computation process. Note, FIGS. 12 and 13 are not necessarily drawn to scale; generally, S₁ will be shorter than S₂ and S₃.

Hyperbolic geolocation is accomplished in two stages and is explained in detail, for example, in “Position Location Using Wireless Communications on Highways of the Future,” IEEE Communications Magazine, October 1966. The first stage involves estimating the signal from the source, between pairs of receivers. The second stage transforms the estimated signals, by various algorithms (i.e., Taylor-Series algorithms), into range difference measurements, resulting in a solution that estimates the transmitter position (e.g., see FIG. 13).

With reference again to FIG. 1, any of the geolocation techniques described above will produce geolocation information that includes latitude and longitude values (and even altitude and velocity values), utilizing only the communications signal of the wireless transmitter 20 and the system 10 for geolocation of wireless transmissions. In fact, if the wireless transmitter (e.g., cell phone) is stationary long enough (e.g., 10 seconds), the system 10 for geolocation of wireless transmissions provides the equivalent of an inverted GPS that locates the cell phone with precision (probably within 10 feet). The system 10 for geolocation can apply various statistical methods, such as that used in statistical GPS, to improve precision. Statistical GPS maps the average of multiple geolocation readings over time. The more readings that are accomplished (GPS is one reading per second), the more accurate the geolocation information will be.

Multiple inquiry embodiments of the system 10 also utilize the TDOA or PDOA processing techniques described herein. However, the multiple inquiry system can address multiple geolocation inquiries by using a geolocation processor with the power of multiple digital processors or of an optical signal processor located in each cell tower 12.

The number of geolocation inquiries that can be simultaneously handled within a cellular grid is described by the following formula:

$$\frac{n}{d + 1} ( m - d )$$

where n is the Processor Configuration, m is the number of cell towers in a cellular grid, d is the dimensionality, and d+1 is the Geolocation Configuration.

With continued reference to FIG. 1, the Processor Configuration, n, is the number of digital processors or the equivalent number of processors internal to an optical processor 14 located in a single cell tower 12. For example, if the Processor Configuration is 100 digital processors per cell tower 12, the geolocation processor 14 at each cell tower comprises 100 digital processors. The more digital processors (or equivalent number of processors internal to an optical processor) that are positioned in each tower, the more geolocation inquiries (e.g., “911” calls, government inquiries, and/or user-based inquiries) that can be handled simultaneously or in each Processing Cycle. A Processing Cycle is the time required by a geolocation processor 14 to perform one TDOA (or PDOA or etc.) calculation. A single digital processor can accomplish one TDOA calculation at a time. Multiple digital processors or an optical processor with equivalent internal processors can accomplish multiple TDOA calculations simultaneously.

Geolocation Configuration, d+1, is a specification as to the desired level of geolocation information (e.g., if bearing, latitude, longitude, altitude, and velocity are requested, d+1=6), as defined by the requester. The accuracy of the Geolocation Configuration, as measured by CEP, is inversely proportional to the number of Processing Cycles (as opposed to the number of digital processors that simultaneously process the information). Therefore, the more Processing Cycles required for the TDOA calculations needed to determine the desired geolocation information, the lower the accuracy. Consequently, multiple digital processors performing the same TDOA calculations as a single processor will determine the desired geolocation information with greater accuracy.

The following are examples of systems for geolocation of wireless transmissions, with the Processor Configurations and Geolocation Configurations as defined by the above formula. Example 1—a Processor Configuration utilizing 100 digital processors per cell tower for the TDOA: The Geolocation Configuration for this example is set to accomplish triangulation (using a primary cell tower and two secondary cell towers) in order to address a geolocation level of latitude and longitude. Per these configurations, the system 10 may then handle 33 geolocation inquiries simultaneously within a cell tower. This number of geolocation inquiries may also be called the cell tower tracking limit. The grid tracking limit (i.e., the number of wireless transmitters that can be geolocated within a grid) would be the cell tower tracking limit times (m-2).

Example 2—a Processor Configuration utilizing 1,000 processors (e.g., 1,000 discrete digital processors or an optical processor with 1,000 equivalent internal processors) per cell tower for the TDOA: The Geolocation Configuration for this example is set to accomplish quad-angulation (using a primary cell tower and three secondary cell towers) in order to address a geolocation level of latitude, longitude, and altitude. This system configuration would then be able to handle 250 wireless transmissions within a cell tower. The grid tracking limit would be this number (i.e., the cell tower tracking limit) times (m-3).

With reference again to FIG. 1, the examples above illustrate that the system 10 for geolocation of wireless transmissions is scalable through the Processor Configuration and Geolocation Configuration to accommodate increasing numbers of geolocation inquiries. These configurations may be dynamically changed, depending upon (a) whether the circumstances require lower or higher levels of geolocation information (i.e., bearing, latitude, longitude, altitude, velocity), (b) whether more or less accurate information (i.e., CEP) is desired, and (c) the number of simultaneous inquiries demanded of the system.

With reference now to FIG. 6, shown is a diagram of an embodiment of a system for geolocation utilizing an optical processor 50, as described in U.S. Pat. No. 6,424,754, as the geolocation processor 14. The optical processor 50 includes one or more internal apparatus for modulating a coherent constant amplitude optical wave in response to a primary signal (S₁) and one or more secondary signals (S₂, S₃, S₄, . . . ). The apparatus comprises an optical waveguide arrangement arranged to be responsive to the optical wave (See FIG. 6). A first pair of electrodes connected to be responsive to the first source and coupled to a first portion of the optical waveguide arrangement modulates the optical wave propagating in the first portion of the optical waveguide arrangement. A second pair of electrodes connected to be responsive to the second signal source and coupled to a second portion of the optical waveguide arrangement modulates the optical wave propagating in the second portion of the optical waveguide arrangement. The first and second portions of the optical waveguide arrangement are opposing and coupled so that the resulting third modulated coherent optical wave contains the sum and difference frequencies of the first and second sources (φ₁₋₂, φ₁₋₃, φ₁₋₄). The resulting value(s) is directly proportional to the direction from the adjacent towers (CT #1-to-CT #2, CT #1-to-CT #3, CT #1-to-CT #4), the combination of which provides a unique geolocation from CT1 (See FIG. 1). As such, an optical processor 50 may be used as the geolocation processor 14 described herein.

The following is an exemplary description of a method for geolocation of wireless transmissions. The method may be performed by the system 10 illustrated in FIG. 1. As described in the setup below, the system 10 includes a Processor Configuration of 100 digital processors (as the geolocation processor 14) per cell tower 12 and the desired level of geolocation information is latitude, longitude, and altitude (i.e., d+1=4). Consequently, quad-angulation calculations are required. These quad-angulation calculations may be performed by the geolocation processors at four (or more) cell towers 12 using the signal data from each cell tower. Alternatively, these quad-angulation calculations may be performed by the geolocation processor(s) at one (or more) cell tower(s) using the signal data from four (or more) cell towers.

Initial Setup:
Inquiry by Central System Administrator
Processor Configuration: 100 processors per cell tower
Geolocation Configuration: latitude, longitude, and altitude (quad-angulation).

The Process (Refer to FIG. 1):
1. A request for geolocation of a cell phone or other transmitter (e.g., a pager) is initiated by, e.g.:
   User dialing emergency response phone number (“911”)
   User dialing a special phone number (e.g., “211”)
   Government request to the telephone company
2. The cell phone system CSA uploads the phone number and Geolocation Configuration to all cell tower databases in the grid.
3. All cell phones are identified by the primary cell tower (strongest signal [S1], primary link) and compared to the target phone number in the cell tower database.
   “911” calls have highest priority and are a superset to the cell tower database.
   User-requested geolocation inquiries (i.e., “211” calls) have the lowest priority.
   If the number of calls (“911” and “211” calls from cell phones combined with government geolocation requests) approaches the tracking limit (e.g., 33-tracking limit [see Example 1 above]), the CSA is notified of the saturation level. Then a Dispatcher can lock out additional “211” calls in order to support additional “911” calls, thereby achieving geolocation “triage.”
4. The transmitting cell phone is identified by the primary cell tower (CT #1) (i.e., the one receiving the strongest signal) from the cell tower database.
   All incoming calls are checked against the database.
   In this configuration, up to 33 transmitters can be tracked simultaneously.
   The primary cell tower (CT #1) has “a priori” knowledge of the precise geolocation of itself and of surrounding cell towers (cell towers are accurately surveyed routinely, depending on geological activity). The primary cell tower geolocation processor requests secondary signal information (time and strength) from the surrounding cell towers for the identified cell phone number. The primary cell tower geolocation processor sorts the secondary site signals by signal strength. The signal strengths of the secondary site signals are weaker than the transmitter's signal strength (S₁) at the primary cell tower (CT #1). The secondary sites with the three next strongest signals (S₂, S₃, and S₄) are identified as CT #2, CT #3, and CT #4.
5. The cell phone transmitter is tracked by the primary cell tower (CT #1), which requests secondary signal information from surrounding cell towers via a dedicated link (cellular link, T1, modem, etc.).
6. The primary cell tower uses its geolocation processor to process the primary signal (S₁) with all secondary signals (S₂, S₃, and S₄). Each secondary signal is arranged by signal strength (S₁>S₂>S₃>S₄).
7. The primary cell tower geolocation processor calculates, e.g., the TDOA between S₁ and S₂ to determine the bearing to the transmitter and the phase shift between S₁ and S₂ (e.g., see FIG. 18). The phase shift is applied to S₁ and compared to S₂, S₃, and S₄. This provides the equivalent bearing as if processed by each secondary cell tower against S₁. Other geolocation techniques may be used.
8. The number of secondary signals is determined by the Geolocation Configuration (bearing; bearing and distance; latitude and longitude; latitude, longitude, and altitude; latitude, longitude, altitude, and velocity).
9. If the primary cell tower Processor Configuration
   is single digital processor capable, then each signal is processed separately;
   is multiple digital processor or optical processor capable, then the number of secondary signals processed simultaneously is dependent on the Geolocation Configuration and Processor Configuration (see example in text).
10. The initial bearing angle from S₁ & S₂ and strength of the secondary signals determines all future secondary cell towers from which secondary signal information will be requested.
11. All bearings (TDOAs) from secondary cell towers are processed using the primary cell tower geolocation processor as if it were the secondary cell tower geolocation processor (using twice the delay time), thereby providing the primary cell tower (CT #1) processor with bearing information from all surrounding cell towers.
12. The primary cell tower (CT #1) geolocation processor calculates geolocation information and records the time of calculation.
13. This information is relayed to the inquirer.
   If the inquirer is the CSA (second party), then the information is not gathered by the cell tower database, but is passed back to the CSA database for records. This may be useful in tracking “cloned” cell phone numbers, based upon complaints by the user of wrongfully charged numbers. At present this is not an issue because of the use of cell phone “fingerprinting,” e.g., developed by TRW. But, this or other scenarios may generate a 2^{nd} party inquiry.
   If the inquirer is the “911” Dispatcher (third party) then the cell tower database (CT database) is updated with this number for tracking purposes and has the highest priority. The CT database processor stores and sends the geolocation information to the CSA. Here the information is forwarded to the proper “911” Dispatcher and stored for future “911” statistics for the FCC. The proper Dispatcher is determined by the geolocation, not by the cell tower grid receiver, which will eliminate the use of Dispatchers from outside the area and reduce the response time.
   If the requester is the cell phone user (1^{st} party), then the information is sent to the user's cell phone and a record is sent to the CSA for billing.
   If the requester is a first responder to a “911” call, then the geolocation information is sent to the requester and a record is sent to the CSA for billing.
   If the requester is an authorized third party (e.g., a law enforcement agency), then the geolocation information is sent to the requester and a record is sent to the CSA for billing.
14. The processed information and known data (e.g., latitude, longitude, altitude, time, and phone number(s) of user and of requester) can be extracted from the database for billing purposes.
15. Billing information is generated by associating the requester with the CSA database information wherein the association is independently determined for each use of the system. In one configuration, the cell phone user and the geolocation requester are the same entity. In another configuration, the cell phone user and the geolocation requester are different entities.

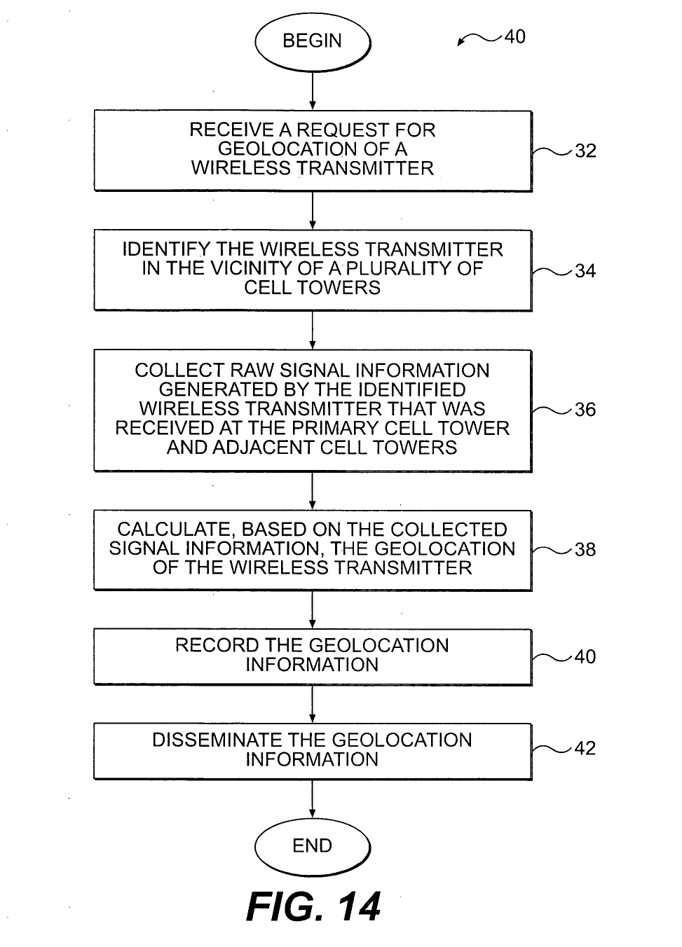

With reference now to FIG. 14, shown is a flowchart of a method 30 for geolocation of a wireless transmitter, which may be performed per the above description. As shown, a request for geolocation of a wireless transmitter, block 32, is received. As described herein, the request may be from a user, a government entity, an emergency (“911”) request, a non-emergency “where am I?” (“211”) request, a cell-phone utility request, etc. The request includes an identifier that identifies the wireless transmitter. The identifier may be a cell-phone number. The wireless transmitter is identified in the vicinity of a plurality of cell towers, block 34. The raw signal information generated by the identified wireless transmitter is received at a primary cell tower and adjacent cell towers and collected, block 36. The signal information of the wireless transmitter is collected at the primary cell tower. Based on the collected signal information, one or more geolocation processors at one or more cell towers calculate(s) the geolocation of the wireless transmitter, block 38. The geolocation processor(s) at the primary cell tower may perform this calculation. Once calculated, the geolocation information is disseminated, block 40. The geolocation information may be disseminated to the requester or a third party(ies). The calculated and disseminated geolocation information may be recorded, block 42. The record is uploaded to, and maintained by, CSA 18 for billing purposes.

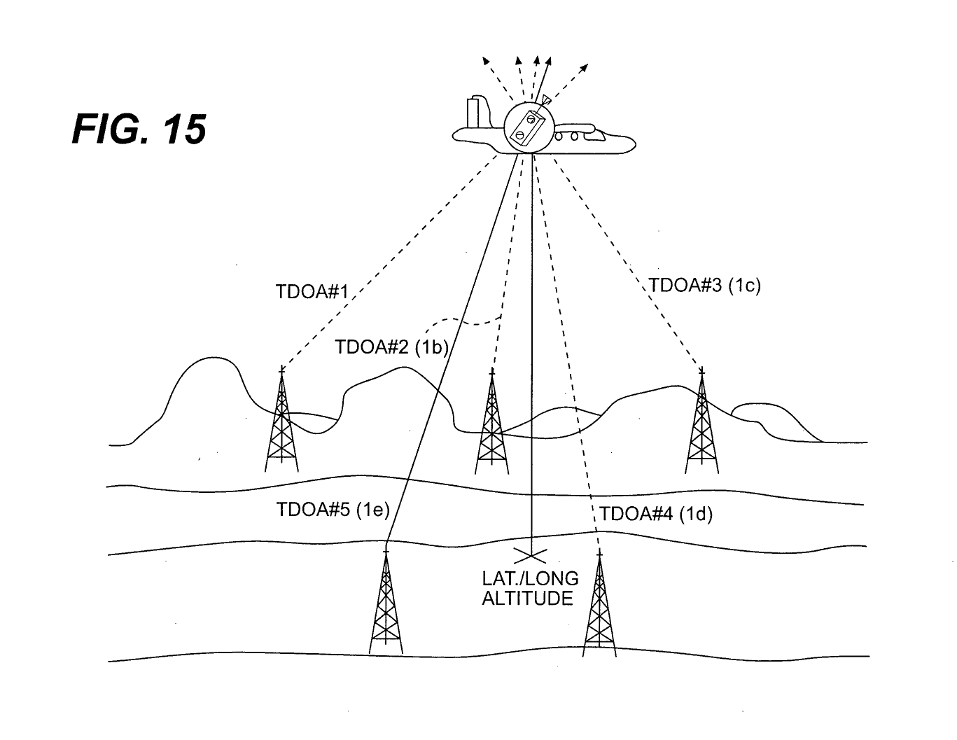

Uses of the system 10 for geolocation of wireless transmissions may include:
Identification of the location of the cell phone user who dials “911”;
Identification of the location of the cell phone user who is lost, who dials “211” (or other designated phone number);
Identification of the location of lost or stolen cell phones that are powered on;
Identification of the location of stolen vehicles with known cell phones inside, if they are powered on;
Identification of the location of airborne cell phones, for use by the FAA during times of in-flight emergencies (e.g., see FIG. 15);
Providing location information to Personal Digital Assistant devices with cell phone capability and other wireless devices (e.g., pagers and Blackberry devices);
Satisfying the FCC's E-911 requirement for providing location information to “911” dispatchers relating to the origin of each “911” call placed by a cell phone;
Providing geolocation information for non-stationary cell phone users; and,
Providing geolocation information for large numbers of “911” calls, simultaneously, during emergencies.

The system 10 for geolocation of wireless transmissions includes the following features and advantages:
Distributed geolocation processors capable of handling multiple geolocation requests per cell tower simultaneously;
The critical communication links involving the signal of interest are held to a minimum (i.e., between cell towers), and thus can be addressed by less expensive links. Only the processors in the cell towers nearest the cell phone caller need to communicate;
The system 10 may provide not only bearing angle from the primary cell tower, but also can address triangulation (and higher) navigation processes so as to provide any range of navigation solutions (i.e., latitude, longitude, altitude, and velocity) associated with each mobile cell phone;
The system 10 can track airborne cell phones in emergencies, e.g., as illustrated in FIG. 15;
The system 10 can determine the velocity value associated with each cell phone user, which can be used to improve traffic handling by facilitating the prediction of user traffic flow through the cellular grid;
The system 10 can distinguish between “911”-generated geolocation inquiries, user-requested geolocation inquiries, and database-requested geolocation inquiries;
The system 10 can be used to generate a revenue stream each time it is used to provide geolocation information (i.e., to an emergency response team concerning a “911” cell phone call, to a lost person calling for geolocation information, or to a third-party requester [e.g., a government request]). A fee may be paid, for example, by the cell phone utilities (i.e., the company that owns the tower in which the processor is located);
The cell phone utility can derive revenues from providing geolocation information directly to cell phone users in response to their requests (e.g., via “211” calls), similar to billings for “411” service, and to third-party requesters (e.g., law enforcement agencies);
The system 10 may include, as the geolocation processor at the cell towers, single digital processor (DSP), multiple digital processor, or optical signal processor (OSP) technology;
The system 10 may include Global Positioning System (GPS) navigation tools (e.g., statistical GPS and differential GPS technology) to generate precision geolocation information;
The system 10 exceeds the FCC requirements for E-911;
Processing speed is improved over existing technology because the processors are co-located with the cell towers and no processing link to a central base processor is necessary;
Existing cell phone handsets require no modification (e.g., no additional antennas or GPS capability);
The system 10 eliminates the atmospheric errors that are inherent in GPS technology (reflected signals only momentarily affect the CEP); and
For GPS-equipped cell phones, the system 10 serves as a backup to the GPS geolocation system in the event of GPS failure.

The system 10 for geolocation of wireless transmissions competes favorably with GPS technology for several reasons:
(1) It is less expensive to install an “array” of processing chips in existing cell towers, as in the system 10, than it is to build and launch a constellation of GPS satellites;
(2) The system 10 for geolocation of wireless transmissions will work with all existing cell phones manufactured and used today, not just those equipped with GPS capability. Therefore, it has universal appeal;
(3) From a safety and public service standpoint, when a caller in distress calls “911,” that single call will automatically trigger a geolocation “tag” for use by emergency response teams;
(4) The system 10 for geolocation of wireless transmissions does not have the inherent problems of a GPS system in a high-rise building environment, where the buildings cause secondary signal interference, thereby generating false geolocation information; and
(5) If a lost caller wants geolocation information, it is far more likely that he or she will have a standard cell phone in his or her possession than a GPS handset or a GPS-capable cell phone. In this event, the lost person can make a “where am I?” geolocation request by dialing “211” (or such other number designated for accessing instant geolocation information) and receive geolocation information describing their whereabouts.

The above-described system and method can be used to satisfy the Federal Communication Commission's minimum requirement (“e911”) for geolocation of “911” calls placed from cell phones. The system and method can also be used to provide geolocation information to an authorized entity (e.g., a law enforcement agency) that has generated a standing request to track the wireless transmitter. In addition, they can be used to provide geolocation information to the user of a cell phone who dials a predetermined number (e.g., “211”) to ascertain their whereabouts. The geolocation information will be transmitted back to the cell phone where it will be presented in a manner determined by the cell phone manufacturer.

The foregoing provides illustration and description, but is not intended to be exhaustive or to limit the invention to the embodiments disclosed. Modifications and variations are possible consistent with the above teachings or may be acquired from practice of the embodiments disclosed. Therefore, it is noted that the scope is defined by the claims and their equivalents.

1. A system for geolocation of wireless transmissions comprising:
multiple cell towers and a central system administrator (CSA) linked to the cell towers, wherein each cell tower includes:
a geolocation processor capable of performing geolocation calculations for wireless transmitters; and
a database.

2. The system of claim 1, wherein each cell tower further includes a local database.

3. The system of claim 1, wherein the CSA includes a central processor for:
the uploading and collection of local databases; and
the collection of billing information.

4. The system of claim 1, further comprising one or more wireless transmitters.

5. The system of claim 1, wherein the geolocation processor comprises a digital processor.

6. The system of claim 1, wherein the geolocation processor comprises multiple digital processors.

7. The system of claim 1, wherein the geolocation processor comprises an optical processor.

8. The system of claim 1, wherein the geolocation processor performs time difference of arrival (TDOA) calculations to determine the geolocation of a wireless transmitter.

9. The system of claim 1, wherein the geolocation processor performs phase difference of arrival (PDOA) calculations to determine the geolocation of a wireless transmitter.

10. The system of claim 1, wherein the geolocation processor performs triangulation calculations using transmitter signal readings from a primary cell tower and two or more secondary cell towers to determine the geolocation of a wireless transmitter.

11. The system of claim 10, wherein the triangulation calculations determine the latitude and longitude of a wireless transmitter.

12. The system of claim 1, wherein the geolocation processor performs quad-angulation calculations using transmitter signal readings from a primary cell tower and three or more secondary cell towers to determine the geolocation of a wireless transmitter.

13. The system of claim 12, wherein the quad-angulation calculations determine the latitude, longitude, and altitude of a wireless transmitter.

14. The system of claim 1, wherein the geolocation processor performs calculations to determine the latitude, longitude, altitude, and velocity of a wireless transmitter using transmitter signal readings from a primary cell tower and four or more secondary cell towers.

15. The system of claim 2, wherein the local database includes means for storing wireless transmitter identifiers to be automatically geolocated.

16. The system of claim 2, wherein the local database includes geolocation requests by wireless transmitter identifier and Geolocation Configuration information, for link to the CSA.

17. A method for geolocation of wireless transmissions comprising:
receiving a request for geolocation of a wireless transmitter, the request including an identifier that identifies the wireless transmitter;
identifying the wireless transmitter in the vicinity of a plurality of cell towers;
collecting, from a primary cell tower and adjacent cell towers, raw signal information generated by the identified wireless transmitter;
calculating, based on the collected raw signal information, the geolocation of the wireless transmitter; and
disseminating the geolocation information.

18. The method of claim 17 further comprising recording the geolocation information.

19. The method of claim 18 wherein the recording includes storing in a database the geolocation information, which includes the identifier, the calculated geolocation information, a time/date stamp for the geolocation, and the identification of the requester.

20. The method of claim 17 wherein the collecting step collects the raw signal information at the primary cell tower.

21. The method of claim 17 wherein the identifier is a cell phone number and the identifying includes comparing the identified cell phone number to a list of cell phone numbers contained in a cell tower global database.

22. The method of claim 17 wherein each time a request for geolocation of a wireless transmitter is received the request is stored.

23. The method of claim 17 wherein each time a signal is received from a wireless transmitter with an identifier that matches an identifier in the global database, the calculating step calculates the geolocation of the wireless transmitter and the geolocation information is stored in a global database.

24. The method of claim 17 wherein the geolocation request is received from a governmental agency.

25. The method of claim 17 wherein each time a geolocation request is received from a wireless transmitter or a “911” operator, the calculating step calculates the geolocation of the wireless transmitter and the geolocation information is stored in a local database.

26. The method of claim 17 wherein the geolocation request is received from a user of the wireless transmitter.

27. The method of claim 17 wherein the geolocation request is generated by a “911” call from the wireless transmitter.

28. The method of claim 17 further comprising receiving a plurality of requests for geolocation information regarding a plurality of wireless transmitters.

29. The method of claim 28 further comprising one or more geolocation processors prioritizing the plurality of requests for geolocation information.

30. The method of claim 17 further comprising one or more geolocation processors simultaneously calculating the geolocation of a plurality of wireless transmitters.

31. The method of claim 17 wherein the calculating includes performing time difference of arrival (TDOA) calculations.

32. The method of claim 31 wherein the performing TDOA calculations determines a TDOA for the primary cell tower, a TDOA for a first secondary cell tower, and a TDOA for a second secondary cell tower, wherein an intersection of the TDOAs determines the geolocation of the wireless transmitter.

33. The method of claim 17 wherein the calculating includes performing phase difference of arrival (PDOA) calculations.

34. The method of claim 17 wherein the calculating includes determining a region where the wireless transmitter is located.

35. The method of claim 34 wherein the determining a region step is performed by comparing intersecting arcs.

36. The method of claim 17 wherein the calculating includes determining a distance of the wireless transmitter from a cell tower based on the power settings of the wireless transmitter.

37. The method of claim 17 wherein the disseminating includes transmitting the geolocation information to a requester.

38. The method of claim 17 wherein the disseminating includes transmitting the geolocation information to a third party.

39. The method of claim 17 further comprising transmitting the geolocation information regarding the wireless transmitter to a central system administrator (CSA).

40. The method of claim 17 further comprising receiving a fee for providing the geolocation information.

41. The method of claim 17 further comprising transmitting instructions for performing the calculating to a geolocation processor.

42. A computer readable medium containing instructions for geolocation of wireless transmissions by:
receiving a request for geolocation of a wireless transmitter, the request including an identifier that identifies the wireless transmitter;
identifying the wireless transmitter in the vicinity of a plurality of cell towers;
collecting, from a primary cell tower and adjacent cell towers, raw signal information generated by the identified wireless transmitter;
calculating, based on the collected raw signal information, the geolocation of the wireless transmitter; and
disseminating the geolocation information.

43. The computer readable medium of claim 42 wherein one or more digital signal processors perform the calculating.

44. The computer readable medium of claim 42 wherein an optical signal processor performs the calculating.

45. The computer readable medium of claim 42 further comprising recording the geolocation information.

46. A method of generating revenue based on geolocation requests comprising:
receiving a request for geolocation of a wireless transmitter;
calculating the geolocation of the wireless transmitter;
disseminating the geolocation information; and
charging a fee for the geolocation transaction.

47. The method of claim 46 further comprising recording the geolocation information.

48. The method of claim 47 wherein the recording comprises:
storing a record of the geolocation request in a database; and
associating the record of the stored geolocation request with a requester.

49. The method of claim 46 wherein the disseminating comprises providing the geolocation information to the requester.

50. The method of claim 46 wherein the disseminating comprises providing the geolocation information to a third party.

51. The method of claim 46 wherein the charging comprises:
accessing the database;
retrieving the stored record of the stored geolocation request and records of any additional geolocation requests associated with the requester;
calculating a fee based on the retrieved records; and
billing an appropriate entity.
